(19) United States
(12) Patent Application Publication
(10) Pub. No.: US 2013/0168386 A1
(43) Pub. Date: Jul. 4, 2013

(54) METHOD FOR UNIFORMLY HEATING PRODUCTS BY MEANS OF A HIGH-FREQUENCY ELECTROMAGNETIC ALTERNATING FIELD

(71) Applicants: Thomas Pfeiffer, Furth (DE); Peter Eisner, Freising (DE)

(72) Inventors: Thomas Pfeiffer, Furth (DE); Peter Eisner, Freising (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 13/816,002

(22) PCT Filed: Aug. 9, 2011
(86) PCT No.: PCT/EP2011/003991

§ 371 Date: Mar. 5, 2013

(30) Foreign Application Priority Data
Aug. 11, 2010 (DE) 10 2010 033 987.3

(51) Int. Cl. H05B 6/60; H05B 6/10

(52) U.S. Cl. CPC H05B 6/60; H05B 6/10
USPC 219/653; 219/665; 219/772

(57) ABSTRACT

The present invention relates to a method and device for uniformly heating products, the products (8, 15) being heated by a high-frequency electromagnetic alternating field. The method and the device are characterised in that the high-frequency electromagnetic alternating field for heating the products (8, 15) is produced by means of a semiconductor generator (4). By using a semiconductor generator (4), temperature fluctuations in the event of fluctuating load due to the transport of the products (8, 15) through the heating volume (7, 17) are reduced, so that a more uniform temperature of the products (8, 15) can be achieved in the heating process.

### TECHNICAL FIELD

The invention relates to a method and device for uniformly heating products, in particular foodstuff products, pharmaceutical products and/or cosmetic products, the products being heated by a high-frequency electromagnetic alternating field.

Heating methods are required inter alia in order to sterilise and therefore preserve foodstuffs or pharmaceutical products. Examples include the pasteurisation or sterilisation of foodstuffs.

### PRIOR ART

Methods for heating liquid products by means of heat exchangers are known. For example, milk is heated in plate or tube heat exchangers during pasteurisation, is kept at pasteurisation temperature for a defined period, and is then cooled again. This method is established and has been well proven over a long time for liquid foodstuffs.

Preserving cans or glass containers containing vegetables, fruits, ready meals, stews or similar contents are generally heated in hot water systems and hot air systems or in autoclaves and are thereby preserved. When sterilising packaged products in autoclaves, steam or hot water is introduced under pressure at temperatures above 120° C. The steam transfers the energy to the exterior of the cans. From here, the interior of the can is heated almost exclusively via thermal conduction, and therefore the products only reach the desired end temperature in the middle of the canned goods after 30 to 60 minutes.

The same is true when heating liquids containing lumps, such as pieces of meat in sauces or fruits in fruit preparations or jams. These suspensions have to be kept at temperature for a very long period of time until the desired temperature has been reached in the core of the solid pieces by means of thermal conduction.

In both cases, the long heating period may result in a considerable worsening of the taste, the vitamin content and the consistency and colour of the products. Preserved foodstuffs in cans often have inferior eating quality for this reason and demonstrate pronounced changes compared to the fresh starting product, for example compared to fresh fruits.

Products that have to be heated for the purposes of pasteurisation or sterilisation or for other reasons include, inter alia:
packaged foodstuffs, pharmaceutical products and cosmetics in liquid, solid or suspension form in packagings such as glass containers, cans, shells, film pouches, tubes, sausage skins, intestines, and others;
poorly viscous and highly viscous or pasty liquids and pastes, sauces, creams, foams and other multi-phase systems, which may also contain lumps, such as pieces of meat, pieces of fruit, etc., and which cannot be heated or can only be heated very inhomogeneously in conventional plate heat exchangers or tube heat exchangers due to the heterogeneous composition and/or solid content and/or gas content;
substances that lead to the formation of films, crusts and the like at the overheated heat exchanger surfaces; and
substances that are very sensitive to temperature, such as pharmaceutical products, infusion solutions, medical liquid food, or other substances that have to be heated particularly uniformly and gently.

The above-mentioned substances and substance mixtures are referred to as products in the present patent application.

One solution approach for reducing the heating time and therefore for improving the quality of the preserved products lies in rapid penetrative heating by means of electromagnetic alternating fields. In addition to microwave heating, of which the low penetration depth of 5 to 20 mm is insufficient to uniformly heat the above-mentioned products, the use of a high-frequency alternating field (HF heating) in particular lends itself for this purpose. Conventional HF heaters consist of two electrodes arranged in parallel, to which an electric alternating field having a frequency of 27.12 MHz for example and a voltage of 2 to 10 kV is applied. These fields are able to penetrate deep into, and to heat, electrically conductive moist solids and suspensions. Ideally, substances can be heated completely uniformly. To heat packaged products, the packagings can be transported by means of a suitable transport device through the space between the electrodes, the products being subjected for a sufficient period of time to the electric high-frequency fields in said space. To heat liquid or free-flowing products in a continuous method, said products can be pumped through a tube made of an electrically insulating material, which is equipped with electrodes so that the products are exposed to the electric high-frequency field as they pass through the tube.

The objective of HF heating is rapid and uniform and therefore gentle heating of substances that are sensitive to temperature and are unsuitable or are only poorly suitable for conventional heating in heat exchangers. HF heating is selected in many cases to heat products uniformly over the entire cross section, for example with the objective of pasteurisation, sterilisation or preparation. It has been found however that considerable temperature inhomogeneities sometimes occur in HF heaters during operation with the above-mentioned products. The products are heated inhomogeneously, which cancels out the advantage of penetrative heating and may lead to significant product damage.

In the case of packaged foodstuffs for example, pronounced excess temperatures may thus occur particularly at the edges of the packagings, on the exterior and at particularly thin points of the products. Overheating and damage to the products may occur at these points. Similar effects are also to be observed when heating free-flowing products in tubular HF continuous heaters. Highly viscous, pasty liquids, suspensions or lumpy goods (for example sausage products) can be conveyed through the tube for heating. In this case, damage may likewise by caused by strong excess heating. Only insufficient temperatures are reached at some point in the tube, in spite of high temperatures at other points. In individual cases, temperature inhomogeneities are therefore to be found along the direction of flow. This is particularly pronounced in the case of pulsating flows, of which the inhomogeneous flow characteristic is caused in many cases by pulsation in the conveying system (for example in the pump).

In spite of the attempts to homogenise the electric field and the energy density between the electrodes by adapting the electrode geometry, it has not been possible with the known methods according to the prior art to completely prevent overheating and temperature inhomogeneities. This is particularly true for packaged products that are heated in the HF field and for highly viscous liquids and suspensions in HF heater tubes.

The heating of products in an HF heater leads to a fluctuating load of the high-frequency generator. This occurs both in the case of heater tubes as a result of the pulsating flow (already explained) or other effects and also in cases in which lumpy products, for example packaged foodstuffs, are transported through the heating volume predefined by the HF heater. In this case, the heating volume is to be understood to mean the spatial region between the electrodes of the HF heater, in which the products are heated by the coupled-in HF radiation. In this case, a different number of foodstuff packagings may be present in the heating volume at different moments in time. This is true inter alia when a packaging enters the heater section or the heating volume or exits from the heating volume. A greater number of packagings leads to a greater electric load for the generator. Further fluctuations in the load occur when the electric properties of the products change, for example as a result of batch variations in the products.

To avoid this problem, an active control unit can be used that holds the power flow in the load, that is to say in the present example in the foodstuff packagings, at a predefined value via actuators. However, the control unit requires a certain period of time to measure the power flow and to act on the actuators before a control response can ultimately be implemented.

Generators having an impedance matcher are used to power the HF heaters. The impedance matcher for electrically matching the generator to the load (heater volume with the contained products) is also used to control the power flow. To this end, this matcher, also referred to as a matchbox or matching network, is equipped with electromechanically adjustable capacitors and inductors.

The disadvantages of the known methods and devices for heating products by means of a high-frequency electromagnetic alternating field can therefore be summarised as follows:
non-uniform heating of the packaged products along the transport through the HF field;
non-uniform heating of the product flow along an HF heater tube as a result of pulsation during conveyance through the HF field.

The object of the present invention lies in specifying a method and device, with which the above disadvantages of the heating of products in HF fields can be avoided or at least reduced.

### DISCLOSURE OF THE INVENTION

The object is achieved by the method and the device according to claims 1, 7 and 11.

Advantageous embodiments of the method and of the device are disclosed in the dependant patent claims or can be deduced from the following description and the exemplary embodiment.

In the proposed method, the products are exposed to an HF field, which is generated in an HF power generator of semiconductor design. In this case, an HF field is to be understood to mean an electromagnetic field in the frequency range between approximately 10 kHz and approximately 300 MHz, in which the products are heated by dielectric heating. The frequencies 13.56 MHz, 27.12 MHz or 40.68 MHz are preferably used and are approved for industrial applications. Other frequencies are generally also suitable for HF heating however.

The inventors have found that, with use of HF power generators of semiconductor design (what are known as semiconductor generators), lower temperature fluctuations from product to product or packaging to packaging surprisingly occur than with the previously used tube generators. This also applies accordingly for flows in a heater tube.

A semiconductor generator is also connected via an impedance matching network to the load, that is to say is connected to the heating volume arranged between the electrodes with the products or medium located therein. The impedance matching network is preferably equipped with electromechanically adjustable capacitors and inductors.

With the proposed method, the products are preferably transported continuously through the heating volume. In an advantageous embodiment of the method for packaged products, this transport takes place in a liquid medium, preferably a liquid channel, which runs through the HF heater. The electrodes of the HF heater are in this case preferably arranged on either side of the liquid channel. Water can be used as a liquid for example. The fluctuating load, which is generated by the entry and exit of the individual products into and from the heating volume and also by a possible change to the product composition or number of products in the heating volume, surprisingly has a much lesser effect on the temperatures of the products than with use of a tube generator. With the proposed method and the associated device, the products in a batch are thus heated more uniformly at lower thermal load where possible, and complete pasteurisation or sterilisation is simultaneously achieved. A typical rise in temperature of the products when passing through the heating volume from 25° C. to 90° C. in the case of pasteurisation and from 25° C. to 125° C. in the case of sterilisation is encountered in this case.

In a further embodiment of the proposed method and of the associated device, it is not the matching network, but the semiconductor generator itself that is controlled in order to achieve a temperature of the products that is as constant as possible. An increase or decrease of the power flow to the electrodes or a change to the electrode voltage is implemented by electronic actuation or control of the semiconductor generator, and leads to a correspondingly quick thermal response in the heating volume.

Additional possibilities for homogenising the temperature distribution in the heating volume or in the products are provided both by the direct electronic control of the semiconductor generator and by the control of the matching network. Temperature inhomogeneities can be further reduced with corresponding control circuits by the rapid thermal response in the products.

In the case of heating liquid products in a tubular HF heater, temperature inhomogeneities may occur in the product along the direction of flow, for example as a result of regular or irregular pulsation of the flow.

In this situation, a continuous measurement of the flow rate is provided for power control. If this variable is known exactly, the average residence time of the product in the electric field can be established and an average energy consumption of the product and therefore the increase in temperature can be calculated over the product from the power of the field and the average residence time. If the flow rate then changes, for example due to pulsation effects, a compensation can be carried out by matching the field strength. In the case of the HF heater, the control variable available for controlling the field strength is the electrode voltage or the power flow from the HF generator to the HF heater or the electrodes. Alternatively, the power flow and the electrode voltage can also be set via the matchbox, as already mentioned, that is to say the electric matching network formed of capacitors and inductors matches the electrical impedance of the HF heater, for example of an HF heater tube, with the load to be heated therein, that is to say the products conveyed therein, to the electrical impedance of the generator.

Due to a control process of this type, the product temperature in the direction of flow can additionally be homogenised. Further measurands are conceivable, such as the temperature or electrical conductivity of the products, which can be used as measurands to control the power flow.

The heating process of the products and therefore also the homogeneity of the product temperature at the output of the HF heater is subject, in addition to the flow rate, to a range of further influencing variables, which are often subject to considerable fluctuations and disruptions during the actual production process. Key variables include:
the product entry temperature
the thermal capacity of the product
the electrical conductivity of the product.

Fluctuations in these influencing variables can also be effectively counteracted with the method according to the invention with use of a semiconductor generator. A person skilled in the art is able to form an efficient and sufficiently rapid control circuit if these influencing variables are known.

The control process can of course also be applied in cases in which lumpy products, for example packaged foodstuffs, are transported through the heating volume.

The proposed device for carrying out the method comprises a heating volume with electrodes arranged on either side, at least one high-frequency generator, which is connected to the electrodes via a matching network, and a transport facility for transporting the products through the heating volume. The high-frequency generator is formed as a semiconductor generator in the proposed device. In this case, the heating volume may be formed in one embodiment by a liquid channel or a portion of a liquid channel, through which the products are transported by means of the transport facility. The transport facility may be implemented in this case by a conveyor line or a similar facility for guiding the products through the heating volume.

In a further embodiment, the heating volume may also be formed by a portion of a heater tube, through which liquid or free-flowing products are conveyed. In this case, the transport facility can be formed for example by a pump or another conveying element.

In the case of use of a heater tube, a reduction in temperature inhomogeneities in the tube cross section can also be achieved by an alternative embodiment of the device, in which the electrodes are formed such that they have a smaller inter-electrode spacing between their edges running along the longitudinal axis of the tube than between their centres. This alternative embodiment can be implemented both with a tube generator and with a semiconductor generator, wherein a temperature homogenisation that is improved to a greater extent is achieved in combination with a semiconductor generator however.

In advantageous embodiments, the above-described devices also comprise a control of the matching network for matching to varied loads and/or an electronic control of the output power of the semiconductor generator, in each case by means of the corresponding sensors for recording the measurands necessary for the control process.

The proposed method and the associated device will be explained again in greater detail hereinafter on the basis of an exemplary embodiment in conjunction with the drawing, in which:

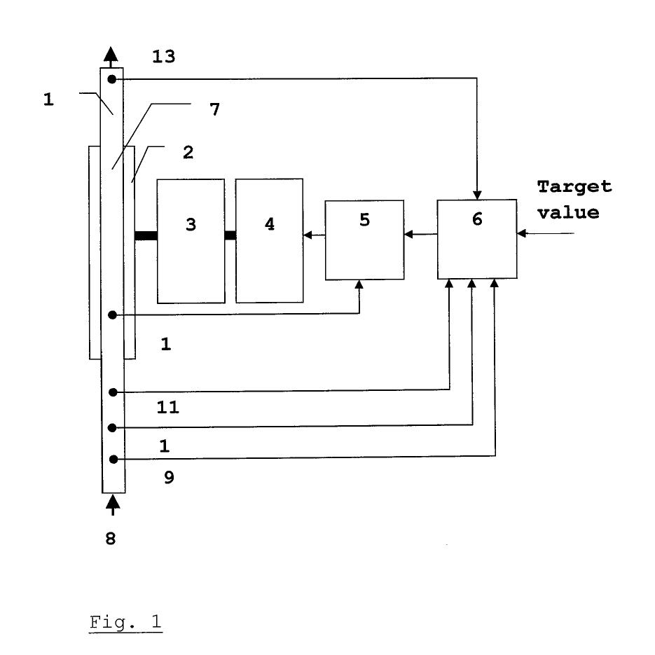

FIG. 1 shows an example of a device for uniformly heating products according to the present invention;

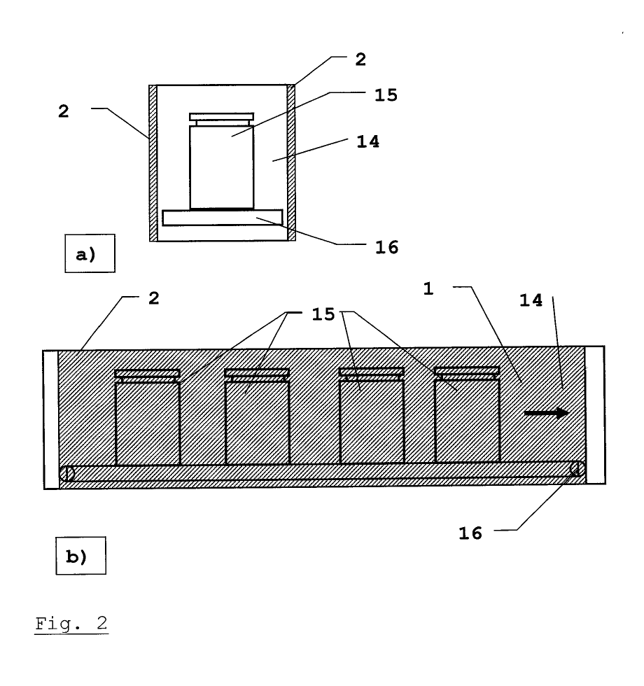

FIG. 2 shows a cross-sectional and longitudinal sectional view through an exemplary liquid channel with electrodes, through which solid products or packagings can be transported so as to be heated uniformly; and

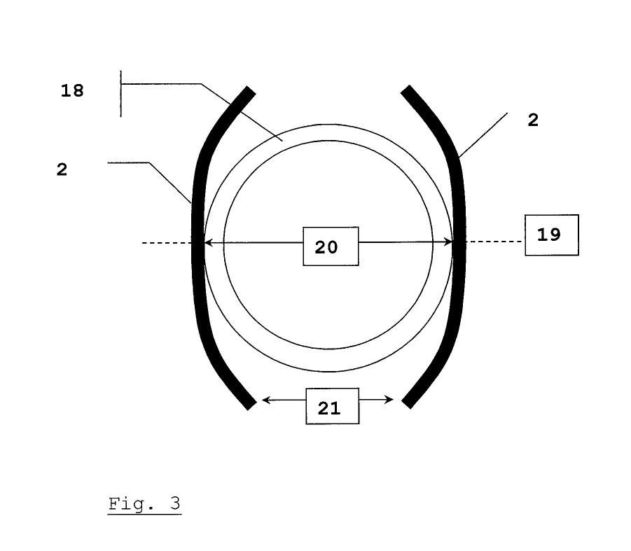

FIG. 3 shows a cross-sectional view through an exemplary tube/electrode arrangement of an HF heater, in which the electrodes have a surface contour for improving the field strength distribution in the cross section of the tube.

In the following exemplary embodiment, the control capability of the combination of an HF generator of semiconductor design with associated matchbox will be used to form an HF heater control unit that detects fluctuations in the influencing variables as early as the entrance of the HF heater tube and already starts to compensate via a feed forward control, before it has a noticeable effect on the control variable of product discharge temperature.

To this end, FIG. 1 shows a highly schematic view of an example for an embodiment of the proposed device with an HF heater tube 1 for free-flowing products, which are conveyed through the tube having the two electrodes 2. The electrodes 2 are connected via a matchbox 3 to a semiconductor generator 4, by means of which the high frequency is generated, which is coupled into the heating volume 7 defined by the two electrodes 2. The product 8 is pumped through the heater tube 1 by means of a pump and is heated as it passes through the heating volume 7. To control the heating, a plurality of measurands are measured in this example. In this example, the device thus comprises one or more sensors 9 for detecting the product flow, one or more sensors 10 for detecting the inlet temperature, one or more sensors 11 for detecting the electrical conductivity of the product, one or more sensors 12 for detecting the electrode voltage and one or more sensors 13 for detecting the discharge temperature. The measured values of the product flow, the inlet temperature, the electrical conductivity and the discharge temperature are fed to the temperature control unit 6, which is connected to the HF power control unit 5, which in turn controls the power of the semiconductor generator 4 accordingly.

FIG. 2 shows an exemplary embodiment of the heater volume as a liquid-filled channel, through which items or packagings are transported. Image a) in this case shows the cross section and image b) shows a longitudinal section through the channel. The channel is equipped with two mutually opposed electrodes 2 and is filled with a liquid 14, for example water. With the aid of a transport device 16, packagings or items 15 are transported through the heater volume 17. The number of packagings present at the same time in the heater volume may fluctuate, and therefore the load of the generator may also fluctuate.

The use of semiconductor generators to generate HF alternating fields can be combined with a series of further measures for continued homogenisation of the temperature distribution in the products. It is thus possible to improve the heating uniformity and to reduce the required electrode voltage as a result of effective dielectric coupling of the electrodes to an HF heater tube.

A HF heater tube is a known embodiment of the high-frequency heater. It is a tube made of a dielectric material, which is acted on by a high-frequency field and through which liquid, pasty foodstuffs or foodstuffs that consist of particle suspensions flow and are heated as they flow through. Good control of the electric field strength in the cross section of the heater tube and the effective coupling of the HF field into the tube are of great significance for the function of such an arrangement. These require a connection, that can be effectively dielectrically controlled, between the electrodes and the tube, which in turn consists of an insulator material (plastic, glass, ceramic, combinations). The electrodes are planar formations made of metal, in the simplest case metal plates, which are arranged on either side of the heater tube and parallel thereto. The electrodes are connected to the matchbox via suitable connection lines for impedance matching and power control, said matchbox in turn being connected to the high-frequency generator provided as a voltage and energy source. A strong electric high-frequency field, which also penetrates the heater tube and the foodstuff flowing therein, is produced in the space between the electrodes as a result of the electrode voltage applied via the generator.

With use of HF heater tubes, it has been found that larger air gaps (>5% of the electrode spacing) between the electrodes and the tube mean that a considerable part of the available electrode voltage is present across the air gap and, as a result, only a small proportion of the electrode voltage is left for the path through the product to be heated. So as to achieve high electric field strengths and high heating rates in the product under these circumstances, very high electrode voltages have to be used, which in turn require complex measures for preventing electric flashovers between the electrodes and between electrodes and system parts.

On the other hand, the reduction of the air gap by advancing the electrodes toward the tube wall leads to non-uniform air gaps (<1% of the electrode spacing) due to mechanical tolerances, and said air gaps can only be controlled with difficulty in tube constructions. Local variations in the air gap between 0 and 1% of the electrode spacing may lead to considerable variations in the electric field strength in the interior of the tube, which in turn cause a local variation in the power input and inhomogeneity of the heating process.

It has been found that both the minimisation of the spacing between the electrodes and tube wall until direct contact and therefore also the minimisation of the necessary electrode voltage for a desired field strength in the product as well as effective control of the field distribution in the tube are possible if the gap between the electrodes and the tube is completely filled with a formable or free-flowing dielectric material, thus avoiding an air gap.

A precondition for the effective function of a filling of this type is that the filler material has a dielectric constant that is much greater than air and the dielectric losses of the material are very low. Furthermore, the material must have sufficient thermal stability in relation to the temperatures prevailing at the heater tube. This filling will particularly advantageously simultaneously provide a fixed connection between electrons and the heater tube, for example by using a mass that is cast between the tube and electrodes, where it sets.

Possible embodiments of the proposed filling include:
deionised water as a coupling medium between the electrodes and the tube wall. The water is characterised by a high dielectric constant and, in the case of the deionised water, simultaneously by very low dielectric losses in the high-frequency range.
a resiliently or hard setting casting compound, which fills the gap between the electrodes and the tube wall. A resilient casting compound is characterised in that temperature gradients in the construction formed of tube material, casting compound and electrode material cannot give rise to any mechanical voltages due to different thermal expansion.
a resiliently or hard setting casting compound, which simultaneously produces a mechanically stable connection between the electrodes and tube wall and therefore renders superfluous additional fixing elements for the electrodes conducting a high voltage.

A practical exemplary embodiment is a resilient casting compound consisting of bicomponent silicone rubber, which additionally ensures electrical coupling for the mechanical connection between the electrodes and the tube.

Besides the embodiment of the filling between the tube wall and the electrode surface, the design, and in this case in particular the profile, of the electrodes are of great significance for uniform heating.

The simplest electrode arrangement for tubular HF heaters for foodstuffs are two flat plates, which are arranged on either side of the tube and parallel thereto. The electric high-frequency field between the electrodes penetrates the tube and the foodstuff flowing therein and heats said foodstuff. If the plate-shaped electrodes are attached very closely to the tube however, so as to minimise the electrode voltage required for rapid foodstuff heating, it has been found that the field distribution and the power input in the tube cross section are very inhomogeneous. This is particularly unfavourable if, in the case of highly viscous products, the product flows in the tube in a laminar manner and the flow is not mixed thoroughly and therefore convective temperature compensation does not occur. Particularly high field strengths and heating rates are achieved in the tube cross section over the shortest connection line from one electrode surface, via the midpoint of the tube, to the other electrode surface (the axis of symmetry of the arrangement, which is arranged perpendicularly on the electrodes).

In this case it has been recognised that the distribution of the electric field strength in the tube cross section can be controlled, and therefore that the power input into the product in the tube cross section can be influenced, by suitably forming the electrodes or the electrode surfaces facing the tube.

In particular, the field strength distribution in the cross section of the tube can be homogenised by reducing the electrode spacing at the edges of the electrodes. To this end, FIG. 3 shows a cross section through a correspondingly formed heater tube 1 with the tube wall 18. The electrodes 2 then have a surface contour that has the greatest spacing from electrode to electrode over the direct connection axis 19 (electrode spacing 20 in FIG. 3) and has the smallest spacing at the electrode edges (electrode spacing 21 in FIG. 3). The smallest possible electrode spacing must be selected so that sufficient electrical insulation for the highest expected electrode voltages is maintained.

Arrangements of a tube and electrodes in which the electrode width is 50% to 200% of the tube outer diameter, the electrode spacing 20 is 100% to 120% of the tube outer diameter, and the electrode spacing 21 is 10% to 90% of the tube outer diameter are particularly advantageous. The optimal spacings also have to be selected in accordance with the geometric and dielectric conditions of the arrangement, in particular in accordance with the dielectric properties of the product in the tube, the tube diameter, the dielectric properties of the tube material, the tube wall thickness, the dielectric conditions in the space between the electrode surface and the tube wall, for example the presence of a dielectric filler, the electrode width and the working frequency of the HF heater.

FIG. 3 shows the exemplary embodiment of a tube/electrode arrangement, which has been constructed and tested. This contour of the electrode surface has a width of 146% of the tube outer diameter, the electrode spacing 20 is 100% of the tube outer diameter, and the electrode spacing 21 is 37% of the tube outer diameter. With a product having a relative dielectric constant of 45, a loss factor of 120, a tube material having a relative dielectric constant of 3.78, a tube outer diameter of 48 mm, a tube wall thickness of 4 mm, a dielectric filler having a relative dielectric constant of 2.7, and a working frequency of 27.12 MHz, an almost ideally uniform field strength distribution and heating uniformity were demonstrated in the tube cross section.

Effects similar to a burning glass in optics can also be achieved by suitable geometric arrangements, and therefore the maximum of the energy density can be placed in practically any volume element in the product, for example over the tube axis.

The electrode contours can be produced by casting, milling out from a metal block or by bending a metal sheet. The efficient dielectric coupling between the electrodes and the tube is preferably achieved by a dielectric filler, as described above.

A further aspect that influences the uniformity of the heating process is the mean power density, that is to say the level of the supplied HF power based on the product volume exposed in the HF field, which is introduced into the product in an HF heater for packaged products or in an HF tube. In this case it has been found that the product is heated unnecessarily slowly with low power densities below 1 W/cm³ and that correspondingly long heater tubes having greater thermal losses, a longer reaction time during control processes, and a greater requirement of pump pressure are required.

On the other hand, very high power densities (greater than 50 W/cm³) increases the risk of non-uniform temperature distribution as a result of hot spots, that is to say as a result of local overheating, which may be detrimental to product quality.

Uniform heating in an HF heater tube is for this reason advantageously achieved with a power density between 1 W/cm³ and 50 W/cm³ so as to largely rule out temperature inhomogeneities and simultaneously to carry out the heating process so quickly that the product quality is protected and the heater tube can be dimensioned in a short and compact manner. Power densities in the range between 4 and 20 W/cm³ have proven to be particularly advantageous; this corresponds to heating rates of 1 K/s to 5 K/s in typical food products.

### LIST OF REFERENCE SIGNS

1 HF heater tube
2 electrodes
3 matchbox
4 semiconductor generator
5 HF power control unit
6 temperature control unit
7 heating volume
8 product
9 sensor for product flow
10 sensor for inlet temperature
11 sensor for electrical conductivity
12 sensor for detecting the electrode voltage
13 sensor for detecting the discharge temperature
14 liquid
15 products/items
16 transport facility
17 heating volume
18 tube wall of the heater tube
19 axis of symmetry perpendicular to the electrodes
20 electrode spacing
21 electrode spacing

What is claimed is:

1-13. (canceled)

14. A method for uniformly heating products, the products being heated by a high-frequency electromagnetic alternating field, which is generated by means of a semiconductor generator,
wherein the products are transported through the high-frequency electromagnetic alternating field in a liquid channel.

15. The method according to claim 14,
characterised in that
the products are transported continuously through a heating volume, in which they are exposed to the high-frequency electromagnetic alternating field.

16. The method according to claim 14,
characterised in that
the high-frequency electromagnetic alternating field is coupled into the heating volume via electrodes, which are arranged on either side of the heating volume.

17. The method according to claim 14,
characterised in that
the high-frequency electromagnetic alternating field is coupled into the heating volume via an electromechanically adjustable matching network for impedance matching, said network being controlled via an active control unit in accordance with the momentary load.

18. A method for uniformly heating products, the products being heated by a high-frequency electromagnetic alternating field, which is generated by means of a semiconductor generator,
wherein the products flow in a tube made of electrically insulating material and are transported through the electric alternating field in the tube.

19. The method according to claim 18,
characterised in that
the products are transported continuously through a heating volume, in which they are exposed to the high-frequency electromagnetic alternating field.

20. The method according to claim 18,
characterised in that
the high-frequency electromagnetic alternating field is coupled into the heating volume via electrodes, which are arranged on either side of the heating volume.

21. The method according to claim 18,
characterised in that
the high-frequency electromagnetic alternating field is coupled into the heating volume via an electromechanically adjustable matching network for impedance matching, said network being controlled via an active control unit in accordance with the momentary load.

22. A device for uniformly heating products by means of a high-frequency electromagnetic alternating field, said device having
a heating volume with electrodes arranged on either side,
at least one high-frequency generator, which is connected to the electrodes via a matching network, and
a transport facility for transporting the products through the heating volume,
wherein the high-frequency generator is a semiconductor generator and wherein the heating volume is formed by a liquid channel or a portion of a liquid channel.

23. The device according to claim 22,
characterised in that
the matching network for matching a modified load is electromechanically adjustable and is connected to an active control unit, which controls the matching network in accordance with the momentary load.

24. A device for uniformly heating products by means of a high-frequency electromagnetic alternating field, said device having
a heating volume with electrodes arranged on either side,
at least one high-frequency generator, which is connected to the electrodes via a matching network, and
a transport facility for transporting the products through the heating volume,
wherein the high-frequency generator is a semiconductor generator and wherein the heating volume is formed by a tube or a portion of a tube made of electrically insulating material.

25. The device according to claim 24,
characterised in that
the matching network for matching a modified load is electromechanically adjustable and is connected to an active control unit, which controls the matching network in accordance with the momentary load.

26. A device for uniformly heating products by means of a high-frequency electromagnetic alternating field, said device having
a heating volume with electrodes arranged on either side,
at least one high-frequency generator, which is connected to the electrodes via a matching network, and
a transport facility for transporting the products through the heating volume,
the heating volume being formed by a tube or a portion of a tube made of electrically insulating material,
characterised in that
the electrodes are formed such that they have a smaller inter-electrode spacing between their edges running along a longitudinal axis of the tube than between their centres.

27. The device according to claim 26,
characterised in that
the high-frequency generator is a semiconductor generator.

28. The device according to claim 26 or 27,
characterised in that
the electrodes have an electrode width measured along the longitudinal axis of the tube that is 50% to 200% of an outer diameter of the tube, and are formed such that the electrode spacing between their edges is 10% to 90% of an outer diameter of the tube, and the electrode spacing between their centres is 100% to 120% of the outer diameter of the tube.

29. The device according to claim 26 or 27,
characterised in that
the electrodes are connected to the tube via a formable or free-flowing dielectric filler, such that there is no air gap between the electrodes and the tube.
